(19) United States
(12) Patent Application Publication
(10) Pub. No.: US 2024/0296500 A1
(43) Pub. Date: Sep. 5, 2024

(54) METHODS AND APPARATUS FOR PREDICTING A PECUNIARY STRENGTH METRIC

(71) Applicant: My Wealth Curve, LLC, Red Bank, NJ (US)

(72) Inventor: John L. Smallwood, Red Bank, NJ (US)

(73) Assignee: My Wealth Curve, LLC, Red Bank, NJ (US)

(21) Appl. No.: 18/116,500

(22) Filed: Mar. 2, 2023

(51) Int. Cl. G06Q 40/06

(52) U.S. Cl. CPC G06Q 40/06

(57) ABSTRACT

A apparatus and method for projecting a pecuniary strength metric, wherein the apparatus includes at least a processor and a memory communicatively connected to the at least a processor, wherein the memory containing instructions configuring the at least a processor to receive a pecuniary datum from a user, generate a plurality of pecuniary scores as a function of the pecuniary datum, identify a plurality of focus areas as a function of the plurality of pecuniary scores, generate a holistic pecuniary strategy as a function of the plurality of focus areas and the plurality of pecuniary scores, and project a pecuniary strength metric of the user as a function of the holistic pecuniary strategy.

### FIELD OF THE INVENTION

The present invention generally relates to the field of financial technology. In particular, the present invention is directed to methods and apparatus for predicting a pecuniary strength metric.

### BACKGROUND

An advanced, comprehensive, easy-to-use apparatus/method with highly personalized strategy and strategy analog is necessary for people in adjusting and relieving financial pressure and improving overall pecuniary strength. Existing solutions are not satisfactory.

### SUMMARY OF THE DISCLOSURE

In an aspect, an apparatus for projecting a pecuniary strength metric, wherein the apparatus includes at least a processor and a memory communicatively connected to the at least a processor, wherein the memory containing instructions configuring the at least a processor to receive a pecuniary datum from a user, generate a plurality of pecuniary scores as a function of the pecuniary datum, identify a plurality of focus areas as a function of the plurality of pecuniary scores, generate a holistic pecuniary strategy as a function of the plurality of focus areas and the plurality of pecuniary scores, and project a pecuniary strength metric of the user as a function of the holistic pecuniary strategy.

In another aspect, a method for projecting a pecuniary strength metric, wherein the method includes receiving, using at least a processor, a pecuniary datum from a user, generating, using the processor, a plurality of pecuniary scores as a function of the pecuniary datum, identifying, using the processor, a plurality of focus areas as a function of the plurality of pecuniary scores, generating, using the processor, a holistic pecuniary strategy as a function of the plurality of focus areas and the plurality of pecuniary scores, and projecting, using the processor, a pecuniary strength metric of the as a function of the holistic pecuniary strategy.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is block diagram illustrating an exemplary apparatus for projecting a pecuniary strength metric;

FIG. 2 is a block diagram of an exemplary machine-learning module;

FIG. 3 is a diagram of an exemplary embodiment of neural network;

FIG. 4 is a diagram of an exemplary embodiment of a node of a neural network;

FIG. 5 is a flow diagram of an exemplary method for projecting a pecuniary strength metric; and

FIG. 6 is a block diagram of a computing apparatus that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatus for projecting a pecuniary strength metric, wherein the apparatus includes at least a processor and a memory communicatively connected to the at least a processor, wherein the memory containing instructions configuring the at least a processor to receive a pecuniary datum from a user, generate a plurality of pecuniary scores as a function of the pecuniary datum, identify a plurality of focus areas as a function of the plurality of pecuniary scores, generate a holistic pecuniary strategy as a function of the plurality of focus areas and the plurality of pecuniary scores, and project a pecuniary strength metric of the user as a function of the holistic pecuniary strategy.

At another high level, aspect of the present disclosure are directed to method for projecting a pecuniary strength metric, wherein the method includes receiving, using at least a processor, a pecuniary datum from a user, generating, using the processor, a plurality of pecuniary scores as a function of the pecuniary datum, identifying, using the processor, a plurality of focus areas as a function of the plurality of pecuniary scores, generating, using the processor, a holistic pecuniary strategy as a function of the plurality of focus areas and the plurality of pecuniary scores, and projecting, using the processor, a pecuniary strength metric of the as a function of the holistic pecuniary strategy.

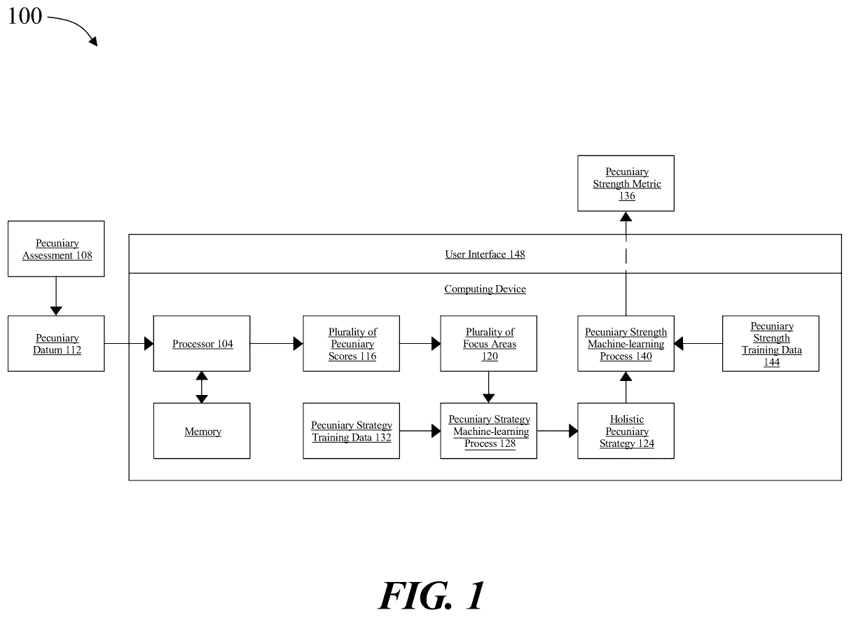

Referring now to FIG. 1, an exemplary embodiment of an apparatus 100 for projecting a pecuniary strength metric is illustrated. Apparatus includes a processor 104. Processor 104 may include any computing device as described in this disclosure, including without limitation a microcontroller, microprocessor, digital signal processor (DSP) and/or apparatus on a chip (SoC) as described in this disclosure. Computing device may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of apparatus 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 includes a memory communicatively connected with processor 104. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, apparatus, apparatus and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, processor 104 is configured to receive a pecuniary datum 112 from a user. As used in this disclosure, “receive” means to accept, collect, or otherwise receive input from a user and/or a device. As used in this disclosure, a “user” may include an individual, a family, an enterprise, and/or other groups of people. As used in this disclosure, a “pecuniary datum” is a data structure containing information regarding to one or more categories. In some cases, category may include, without limitation, finances, lifestyle, physical health, mental health, and the like thereof. Pecuniary datum may be in any data structure described in this disclosure. In a non-limiting example, pecuniary datum may be a vector containing information related to user's finances such as, without limitation, cash reserves, insurance policies, assets, debts, real estate, income, expense, financial goals, retirement accounts, and the like thereof. In some embodiments, pecuniary datum 112 may include a vitality datum. “Vitality datum,” for the purposes of this disclosure, is a data structure containing information regarding a user's overall health. In some cases, vitality datum may include information, such as, wellness, medical records, diseases records, lifestyle, and the like thereof. In a non-limiting example, vitality datum may include a user's eating habits and sleep schedule. Additionally, or alternatively, pecuniary datum 112 may include any personal information related to the user. In some cases, personal information may include, without limitation, user's profession, experience in profession, age, gender, geographical information, family information, employer, and the like thereof.

With continued reference to FIG. 1, a “vector” as defined in this disclosure is a data structure that represents one or more quantitative values and/or measures of pecuniary datum 112. A vector may be represented as an n-tuple of values, where n is one or more values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent, for instance as measured using cosine similarity as computed using a dot product of two vectors; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes.

With continued reference to FIG. 1, in some embodiments, pecuniary datum 112 received from the user may be stored in a data store such as, without limitation, a database. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, in some embodiments, receiving pecuniary datum 112 may include accepting a pecuniary assessment 108 from the user. As used in this disclosure, a “pecuniary assessment” is a set of questions that asks for information in one or more categories as described above. In a non-limiting example, pecuniary assessment 108 may be a financial survey. In some embodiments, receiving pecuniary datum 112 may include accepting a plurality of pecuniary assessment 108, wherein each pecuniary assessment of plurality of pecuniary assessment 108 may target a single category. In other embodiments, pecuniary assessment 108 may include a data submission of a plurality of documentation from the user. As used in this disclosure, a “data submission” is a collection of data provided by the user as an input source. In a non-limiting example, data submission may include user uploading one or more input to processor 104 through one or more internet protocols. As used in this disclosure, a “documentation” is a source of information. In some embodiments, documentation may be a source of information related to the user. In other embodiments, documentation may be a source of information unrelated to the user. In some cases, documentation may include electronic document, such as, without limitation, txt file, word document, pdf file, excel sheet, image, and the like thereof. In some cases, documentation may include, without limitation, paystub, W-2 form, deed, medical bill, account statement, credit report, and the like thereof. In a non-limiting example, documentation may be input source as described above in reference to data submission. Data submission may include user uploading a plurality of paystubs to processor 104 for further processing. Further processing may include any processing step described below in this disclosure.

With continued reference to FIG. 1, in some embodiments, processor may be configured to extract pecuniary datum 112 from one or more documentations described above using a language processing module. Language processing module may include any hardware and/or software module. Language processing module may be configured to extract, from the one or more documents, one or more words. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

With continued reference to FIG. 1, language processing module may operate to produce a language processing model. Language processing model may include a program automatically generated by computing device and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

With continued reference to FIG. 1, language processing module and/or diagnostic engine may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted word, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

With continued reference to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

With continued reference to FIG. 1, language processing module may use a corpus of documents to generate associations between language elements in a language processing module, and diagnostic engine may then use such associations to analyze words extracted from one or more documents and determine that the one or more documents indicate significance of a category. In an embodiment, language module and/or processor 104 may perform this analysis using a selected set of significant documents, such as documents identified by one or more experts as representing good information; experts may identify or enter such documents via graphical user interface, or may communicate identities of significant documents according to any other suitable method of electronic communication, or by providing such identity to other persons who may enter such identifications into processor 104. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, diagnostic engine may automatically obtain the document using such an identifier, for instance by submitting a request to a database or compendium of documents such as JSTOR as provided by Ithaka Harbors, Inc. of New York.

With continued reference to FIG. 1, in some embodiments, processor 104 may process pecuniary assessment 108 and/or data submission of plurality of documentation using optical character recognition or optical character reader (OCR), which includes automatic conversion of images of written (e.g., typed, handwritten or printed text) into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

With continued reference to FIG. 1, in some cases OCR may be an “offline” process, which analyses a static document or image frame. In some cases, handwriting movement analysis can be used as input to handwrite recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

With continued reference to FIG. 1, in some cases, OCR processes may employ pre-processing of image component. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from a background of image component. In some cases, binarization may be required for example if an employed OCR algorithm only works on binary images. In some cases. a line removal process may include removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image component.

With continued reference to FIG. 1, in some embodiments an OCR process will include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at a same scale as input glyph. Matrix matching may work best with typewritten text.

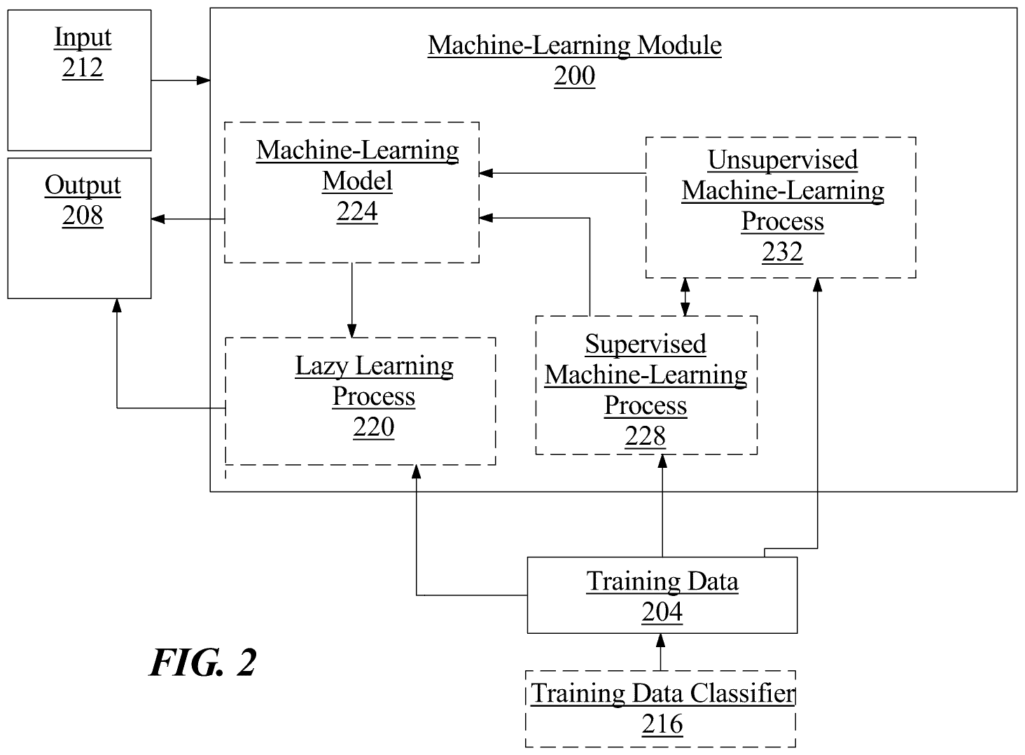

With continued reference to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning process like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIGS. 2-4. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

With continued reference to FIG. 1, in some cases, OCR may employ a two-pass approach to character recognition. Second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool include OCRopus. OCRopus development is led by German Research Centre for Artificial Intelligence in Kaiserslautern, Germany. In some cases, OCR software may employ neural networks, for example neural networks as taught in reference to FIGS. 2-4.

With continued reference to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, processor 104 is further configured to generate a plurality of pecuniary scores 116 as a function of the pecuniary datum 112. As used in this disclosure, a “pecuniary score” is a quantitative evaluation of a category related to the user. Category may be any category described above in reference to pecuniary datum 112. In a non-limiting example, plurality of pecuniary scores 116 may be an evaluation of the user's financial health in plurality of categories such as, without limitation, debt, liquid assets, real estate, income, growth potential, wellness, and the like thereof. In another non-limiting example, generating plurality of pecuniary scores may include generating a first pecuniary score representing a first category and generating a second pecuniary score representing a second category, wherein the first category may be different than the second category. In some cases, plurality of pecuniary scores 116 may be scored as a function of user's income to debt ratio, age, career status, and the like thereof. In a non-limiting example, an increase in income to debt ratio may result in a decrease in pecuniary score 116. In a non-limiting example, a pecuniary score may be generate by adding each value within each category of a plurality of categories, such as, without limitation, monthly income amount, real estate amount, debt amount, monthly expenses amount, and the like, and normalize by a certain threshold, wherein the threshold may be an average of category weights. In other non-limiting examples, plurality of pecuniary datum 112 may be generated using machine-learning process described below in reference to FIG. 2-4.

With continue reference to FIG. 1, in some embodiments, plurality of pecuniary scores 116 may be on a scale of x to y, wherein x may represent a minimum pecuniary score and y may represent a maximum pecuniary score. In a non-limiting example, pecuniary score 116 may be on a scale of 0 to 100, wherein a pecuniary score close to 0 may be a low pecuniary score, and a pecuniary score close to 100 may be a high pecuniary score. Low pecuniary score may indicate a weaker strength in a category, while high pecuniary score may indicate a stronger strength in the category. In some embodiments, without limitation, pecuniary score may be in different scales for different categories. In a non-limiting example, pecuniary score for pecuniary datum 112 may be on a scale of 0 to 100 and pecuniary score for vitality datum may be on a scale of F to A (i.e., F, E, D, C, B, and A).

With continued reference to FIG. 1, in some embodiments, plurality of pecuniary scores 116 may include one or more historical pecuniary scores. As used in this disclosure, a “historical pecuniary score” is pecuniary score that is generated in the past. In some embodiments, each pecuniary score of plurality of pecuniary scores 116 may include an associated timestamp, wherein the associated timestamp is an indicator of time when the corresponding pecuniary score was generated. In some cases, timestamp may include data seconds, minutes, hours, days, weeks, months, years, and the like thereof. In other embodiments, plurality of pecuniary scores 116 may include one or more advanced pecuniary score. As used in this disclosure, an “advanced pecuniary score” is pecuniary score that is generated by a processor over a period of time. Advanced pecuniary score disclosed here will be described in further detail below. In a non-limiting example, an advanced pecuniary score may be a future pecuniary score of the user predicted using machine-learning process as described above in reference to FIGS. 2-4. In some cases, historical pecuniary score and/or advanced pecuniary score may be stored in data store described above in this disclosure.

With continued reference to FIG. 1, in some embodiments, plurality of pecuniary scores 116 may include a pecuniary curve. As used in this disclosure, a “pecuniary curve” is a graphical representation of plurality of pecuniary scores 116. In some cases, pecuniary curve may include a curve, wherein the curve is an object similar to a line but does not have to be straight. Curve may include, without limitation, topological curve, differentiable curve, algebraic curve, and the like thereof. In some embodiments, without limitation, pecuniary curve may be expressed in a two-dimensional (2D) space, wherein the two-dimensional space may consist of a horizontal axis (x-axis) and a vertical axis (y-axis). In a non-limiting example, plurality of pecuniary scores 116 may be visualized through pecuniary curve in two-dimensional space, wherein vertical axis may represent plurality of pecuniary scores 116 and horizontal axis may represent a plurality of associated timestamps. In other embodiments, without limitation, pecuniary curve may be expressed in a multi-dimensional space, wherein the multi-dimensional space may consist of a plurality of axis. Each axis of plurality of axis may represent a single category, such as, without limitation, cash reserves, assets, debts, real estate, income, future growth, wellness, and the like thereof.

With continued reference to FIG. 1, in some embodiments, pecuniary curve may include a curve fitting, wherein the curve fitting is a process of constructing a curve that has a best fit to a series of data points, such as, without limitation, plurality of pecuniary scores 116. In some embodiments, curve fitting may include a process of minimizing a vertical (i.e., y-axis) displacement of a data point (i.e., pecuniary score) from curve. In a non-limiting example, generating a plurality of pecuniary scores 116 may include creating a pecuniary curve as a function of the plurality of pecuniary scores 116, wherein creating the pecuniary curve may include a curve fitting with an interpolation. Interpolation may include one or more methods of finding estimated new pecuniary score based on a range of a discrete set of plurality of pecuniary scores 116. In some cases, interpolation may include piecewise constant interpolation, linear interpolation, polynomial interpolation, spline interpolation, mimetic interpolation, and the like thereof.

With continued reference to FIG. 1, processor 104 is further configured to identify a plurality of focus areas 120 as a function of plurality of pecuniary scores 116. As used in this disclosure, a “focus area” is an area of interest. In some embodiments, this may include an area, field, or otherwise aspect of a user across one or more categories that require special attention. In some embodiments, identifying plurality of focus 120 areas may include comparing a first pecuniary score with a second pecuniary score and identify a focus area as a function of the comparison of the first pecuniary score and the second pecuniary score. First pecuniary score may be a pecuniary score of a first category and second pecuniary score may be a pecuniary score of a second category, wherein the first category may be different than the second category. Focus area may be identified as category with lower pecuniary score. Category may be any category described above in this disclosure. In other embodiments, without limitation, identifying plurality of focus areas 120 may include comparing more than two categories. In a non-limiting example, focus area 120 may be a category with lower pecuniary score 116 and/or pecuniary datum 112. In a non-limiting example, plurality of focus areas 120 may include an area that the user is struggling financially such as, without limitation, excessive debt, expensive habits, unessential large purchases, and the like thereof. In some embodiments, plurality of focus areas 120 may include one or more growth areas, wherein one or more growth area may include areas in one or more categories which the user is excelling. In a non-limiting example, plurality of focus areas 120 may include a plurality of financial growth areas such as, without limitation, successful investments, favorable salaries, career progression, and the like thereof. Additionally, or alternatively, processor 104 may be configured to provide the user with suggestions on how to manage plurality of focus areas 120 in a short term. In a non-limiting example, a user with a high interest debt may be instructed to prioritize paying the debt off prior to beginning to save.

With continued reference to FIG. 1, processor 104 is further configured to generate a holistic pecuniary strategy 124 as a function of plurality of focus areas 120 and plurality of pecuniary scores 116. As used in this disclosure, a “holistic pecuniary strategy” is a pecuniary method, plan, or otherwise strategy for one or more categories. In a non-limiting example, plurality of focus areas 120 may include a focus area of excessive debt with a lowest pecuniary score 116. A holistic pecuniary strategy 124 may be generated, wherein the holistic pecuniary strategy 124 may include one or more process/steps emphasize improving focus area such as, without limitation, debt elimination, building saving, reducing large purchases, and the like thereof. In some embodiments, without limitation, holistic pecuniary strategy 124 may be developed as a function of pecuniary datum 112. In a non-limiting example, holistic pecuniary strategy 124 may be customized based on the user's financial goals within pecuniary datum 112.

With continued reference to FIG. 1, in some embodiments, generating holistic pecuniary strategy 124 may include training a pecuniary strategy machine-learning process 128 using pecuniary strategy training data 132, wherein the pecuniary strategy training data may include a plurality of pecuniary scores 116 as input correlated to a plurality of holistic pecuniary strategies as output, and generating holistic pecuniary strategy 124 as a function of the trained pecuniary strategy machine-learning process. In some embodiments, pecuniary training data may be retrieved from data store, such as, without limitation, database as described above. In other embodiments, pecuniary strategy training data 132 may be manually labeled by the user and/or professional such as, without limitation, a financial advisor. In some embodiments, pecuniary strategy training data 132 may include plurality of historical pecuniary scores. In other embodiments, pecuniary strategy training data 132 may incorporate new determination made by pecuniary strategy machine-learning process 128 as feedback. In a non-limiting example, pecuniary strategy machine-learning process 128 may be a classifier, wherein the classifier may be used to classify a plurality of pecuniary scores 116 to one or more holistic pecuniary strategies 124; A “classifier,” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Processor 104 and/or another device may generate a classifier using a classification algorithm, defined as a process whereby a processor 104 derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. In a non-limiting example, pecuniary strategy machine-learning process 128 may take a pecuniary score vector containing a plurality of pecuniary scores 116: [37, 83, 72, 95, 97], wherein each pecuniary score of plurality of pecuniary scores 116 within the pecuniary score vector may be in a range of 0 to 100 and represent a single category within a plurality of categories: debt, income, real estate, growth potential, and wellness. Pecuniary strategy machine-learning process 128 may take pecuniary score vector as input and output a holistic pecuniary strategy 124, wherein the holistic pecuniary strategy 124 may include one or more process/step emphasizing debt elimination and building saving for improving pecuniary scores for debt and real estate categories while maintaining pecuniary scores for other categories.

With continued reference to FIG. 1, processor 104 is further configured to project a pecuniary strength metric 136 of the user as a function of holistic pecuniary strategy 124. As used in this disclosure, a “pecuniary strength metric” is a measurement of user's overall condition. This may include, as non-limiting examples, financial condition, physical health condition, mental health condition, and the like thereof. In some cases, pecuniary strength metric may include measurements, values, or otherwise parameters regarding to user's health, growth of investments, savings, debts, lifestyles, assets, and the like thereof. As used in this disclosure, “project” pecuniary strength metric 136 means to estimate, predict, or otherwise forecast pecuniary strength metric 136 over a period of time. In some cases, user may determine period of time within a time range such as, without limitation, from current to 20 years after. In a non-limiting example, pecuniary strength metric may include a plurality of advanced pecuniary scores, wherein the plurality of advanced pecuniary scores may be generated as a function of pecuniary strength machine-learning process 140 as described below. Pecuniary strength metric may further include a pecuniary curve that visualize plurality of advanced pecuniary scores. In some embodiments, processor 104 may be further configured to display pecuniary strength metric 136 using a user interface 148. As used in this disclosure, a “user interface” is a device that provides interactions between the user and processor 104. User interface 148 may include a screen. In some cases, user interface 148 may be communicatively connected with processor 104. In other cases, user interface 148 may be electrically connected with processor 104 through one or more wires. User interface 148 may display any other data regarding to apparatus 100 such as, without limitation, pecuniary assessment 108, pecuniary datum 112, plurality of pecuniary scores 116, plurality of focus areas 120, holistic pecuniary strategy 124, and the like thereof. In some embodiments, user interface 148 may be a graphical user interface (GUI). In a non-limiting example, processor 104 may output a pecuniary strength metric 136, wherein the pecuniary strength metric may include a future saving amount of a user with a pecuniary curve showing the growth of the future saving (i.e., climb of the curve within pecuniary curve) of the user. Processor 104 may then display outputted pecuniary strength metric 136 through graphical user interface. Additionally, or alternatively, without limitation, pecuniary strength metric may include a compositional pecuniary score, wherein the compositional pecuniary score may be calculated or generated as a function of plurality of advanced pecuniary scores. In a non-limiting example, compositional pecuniary score may be calculated by normalizing a plurality of advanced pecuniary scores and taking an average of the plurality of advanced pecuniary scores. Additionally, or alternatively, pecuniary strength metric 136 may further include a simulation of holistic pecuniary strategy 124 generated previously. In a non-limiting example, a pecuniary strength metric 136 may be displayed through user interface 148, wherein the pecuniary strength metric 136 may include how implementation and adoption of holistic pecuniary strategy 124 may impact and affect user's financial condition and/or overall health condition.

With continued reference to FIG. 1, projecting pecuniary strength metric 136 may include training a pecuniary strength machine-learning process 140 using pecuniary strength training data 144, wherein the pecuniary strength training data may include a plurality of holistic pecuniary strategies 124 as input correlated to a plurality of pecuniary strength metrics 136 as output, and projecting the pecuniary strength metric as a function of the trained pecuniary strength machine-learning process 140. In some embodiments, pecuniary strength training data 144 may be retrieved from data store, such as, without limitation, database as described above. In other embodiments, pecuniary strength training data 144 may be manually labeled by the user and/or professional such as, without limitation, a financial advisor. In some embodiments, pecuniary strength training data 144 may include a plurality of historical holistic pecuniary strategies, wherein the plurality of historical holistic pecuniary strategies are holistic pecuniary strategies generated previously using plurality of historical pecuniary scores. In other embodiments, pecuniary strength training data 144 may incorporate new prediction made by pecuniary strength machine-learning process 140 as feedback. In some embodiments, pecuniary strength machine-learning process 144 may be used to determine a pecuniary strength metric; this may be performed using, without limitation, linear regression model, least squares regression, ridge regression, least absolute shrinkage and selection operator (LASSO) model, multi-task LASSO model, elastic net model, multi-task elastic net model, least angle regression (LAR), LARS LASSO model, orthogonal matching pursuit model, Bayesian regression, logistic regression, stochastic gradient descent model, perceptron model, passive aggressive algorithm,. Robustness regression model, Huber regression model, or any other suitable model that may occur to person skilled in the art upon reviewing the entirety of this disclosure.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm that will be performed by a processor/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively, or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example inputs may include a plurality of electric potential and time and outputs may include a plurality of current values.

Further referring to FIG. 2, training data may be filtered, sorted, and/or selected using one or more supervised and/or unsupervised machine-learning processes and/or models as described in further detail below; such models may include without limitation a training data classifier 212. Training data classifier 212 may include a classifier. Machine-learning module 200 may generate a classifier using a classification algorithm, defined as a process whereby a processor and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 212 may classify elements of training data to baseline measurement, longevity enhancement threshold, longevity category, and vitality enhancement program.

With continued reference to FIG. 2, Processor 104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Processor 104 may then calculate a likelihood table by calculating probabilities of different data entries and classification labels. Processor 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 2, processor 104 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 2, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 4]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively, or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process including without limitation any process as described above and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs as described above in this disclosure as inputs, outputs as described above in this disclosure as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

Further referring to FIG. 2, machine learning processes may include at least an unsupervised machine-learning processes 222. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

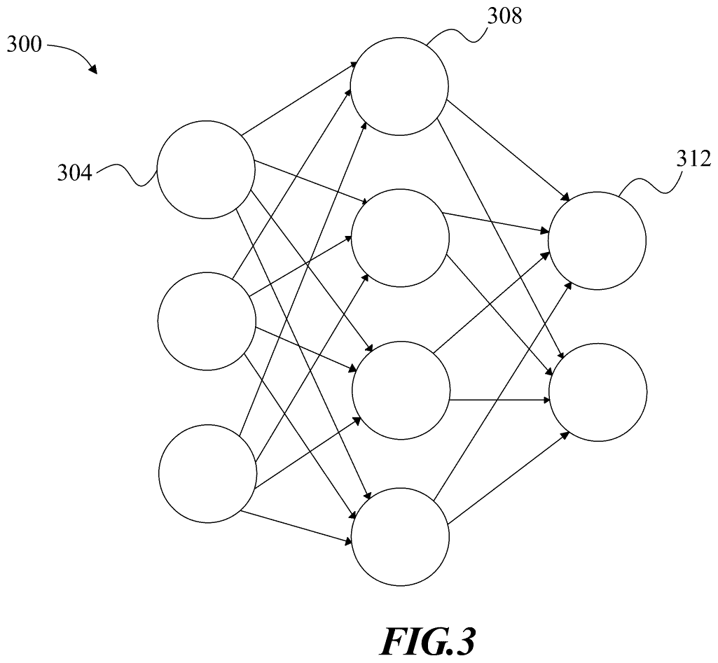

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

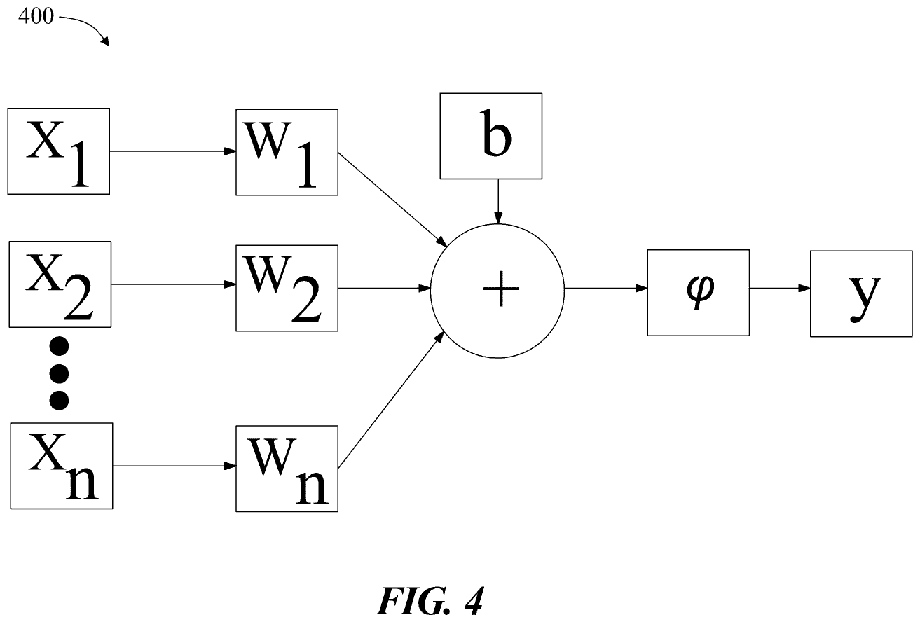

Referring now to FIG. 4, an exemplary embodiment of a node of a neural network is illustrated. A node may include, without limitation a plurality of inputs xᵢ that may receive numerical values from inputs to a neural network containing the node and/or from other nodes. Node may perform a weighted sum of inputs using weights wᵢ that are multiplied by respective inputs xᵢ. Additionally, or alternatively, a bias b may be added to the weighted sum of the inputs such that an offset is added to each unit in the neural network layer that is independent of the input to the layer. The weighted sum may then be input into a function φ, which may generate one or more outputs y. φWeight wᵢ, applied to an input x, may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wi may be determined by training a neural network using training data, which may be performed using any suitable process as described above.

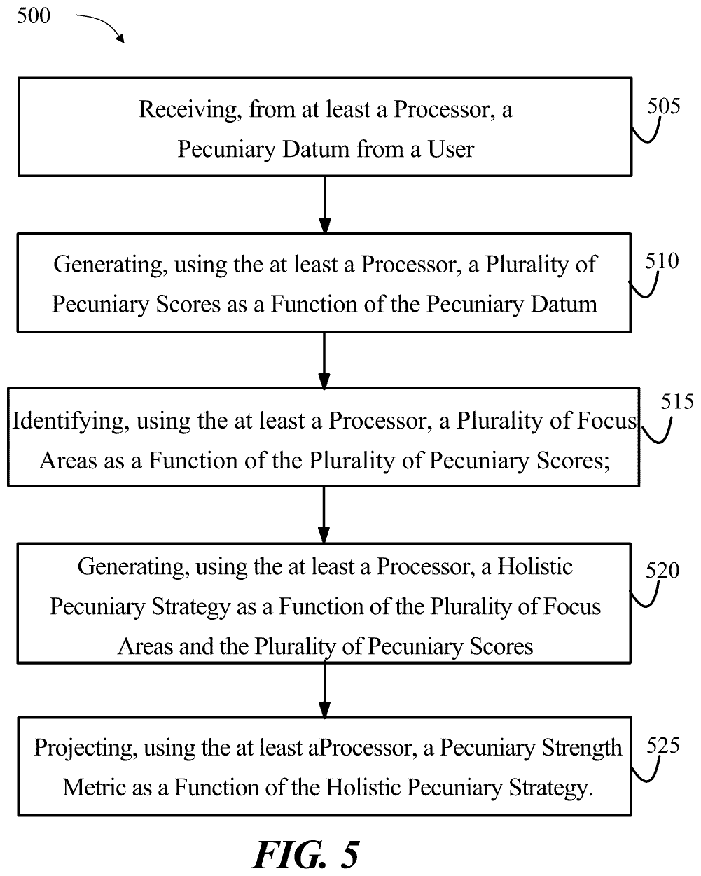

Now referring to FIG. 5, an exemplary embodiment of a method 500 for projecting a pecuniary strength metric is illustrated. Method 500 includes a step 505 of receiving, using at least a processor, a pecuniary datum from a user, without limitation, as described above in reference to FIGS. 1-4. In some embodiments, pecuniary datum may include a vitality datum. This may be implemented, without limitation, as described above in reference to FIGS. 1-4. In some embodiments, step 505 of receiving the pecuniary datum may include accepting a pecuniary assessment from the user and extracting pecuniary datum from the pecuniary assessment. In some embodiments, pecuniary assessment may include a data submission of a plurality of documentation from the user. This may be implemented, without limitation, as described above in reference to FIGS. 1-4.

With continued reference to FIG. 5, method 500 further includes a step 510 of generating, using the at least a processor, a plurality of pecuniary scores as a function of the pecuniary datum, without limitation, as described above in reference to FIGS. 1-4. In some embodiments, plurality of pecuniary scores may include a pecuniary curve. This may be implemented, without limitation, as described above in reference to FIGS. 1-4. In some embodiments, step 510 of generating the plurality of pecuniary scores may include generating a first pecuniary score representing a first category and generating a second pecuniary score representing a second category, wherein the first category is different than the second category. This may be implemented, without limitation, as described above in reference to FIGS. 1-4.

With continued reference to FIG. 5, method 500 further includes a step 515 of identifying, using the at least a processor, a plurality of focus areas as a function of the plurality of pecuniary scores, without limitation, as described above in reference to FIGS. 1-4. In some embodiments, step 515 of identifying a plurality of focus areas may include comparing a first pecuniary score with a second pecuniary score and identify an area of interest as a function of the comparison of the first pecuniary score and the second pecuniary score. This may be implemented, without limitation, as described above in reference to FIGS. 1-4.

With continued reference to FIG. 5, method 500 further includes a step 520 of generating, using the at least a processor, a holistic pecuniary strategy as a function of the plurality of focus areas and the plurality of pecuniary scores, without limitation, as described above in reference to FIGS. 1-4. In some embodiments, step 520 of generating holistic pecuniary strategy may include training a pecuniary strategy machine-learning process using a pecuniary strategy training data, wherein the pecuniary training data may include a plurality of pecuniary scores as input correlated to a plurality of holistic pecuniary strategies as output and generating the holistic pecuniary strategy as a function of the trained pecuniary strategy machine-learning process. This may be implemented, without limitation, as described above in reference to FIGS. 1-4.

With continued reference to FIG. 5, method 500 further includes a step 525 of projecting, using the at least a processor, a pecuniary strength metric of the as a function of the holistic pecuniary strategy, without limitation, as described above in reference to FIGS. 1-4. In some embodiments, pecuniary strength metric may include a plurality of advanced pecuniary scores. This may be implemented, without limitation, as described above in reference to FIGS. 1-4. In some embodiments, step 525 of projecting the pecuniary strength metric may include training a pecuniary strength machine-learning process using a pecuniary strength training data, wherein the pecuniary strength training data may include a plurality of holistic pecuniary strategies as input correlated to a plurality of pecuniary strength metrics as output and projecting the pecuniary strength metric as a function of the trained pecuniary strength machine-learning process. This may be implemented, without limitation, as described above in reference to FIGS. 1-4.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

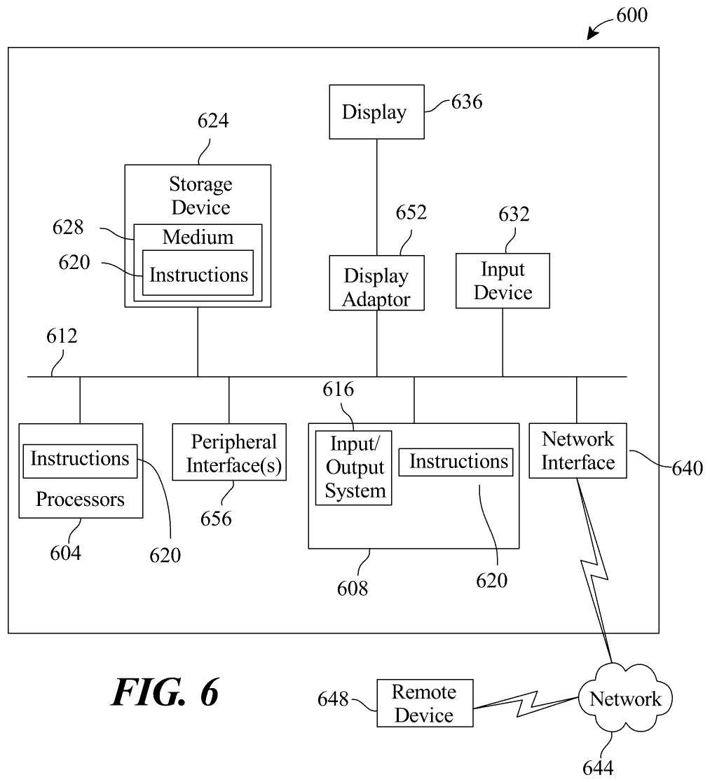

FIG. 6 shows a diagrammatic representation of one embodiment of a computing device in the exemplary form of a computer apparatus 600 within which a set of instructions for causing a control apparatus to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer apparatus 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or apparatus on a chip (SoC).

Memory 608 may include various components (e.g., machine-readable media) including, but not limited to, a random-access memory component, a read only component, and any combinations thereof. In one example, a basic input/output apparatus 616 (BIOS), including basic routines that help to transfer information between elements within computer apparatus 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating apparatus, one or more application programs, other program modules, program data, and any combinations thereof.

Computer apparatus 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer apparatus 600 (e.g., via an external port connector (not shown)). Particularly, storage device 624 and an associated machine-readable medium 628 may provide nonvolatile and/or volatile storage of machine-readable instructions, data structures, program modules, and/or other data for computer apparatus 600. In one example, software 620 may reside, completely or partially, within machine-readable medium 628. In another example, software 620 may reside, completely or partially, within processor 604.

Computer apparatus 600 may also include an input device 632. In one example, a user of computer apparatus 600 may enter commands and/or other information into computer apparatus 600 via input device 632. Examples of an input device 632 include, but are not limited to, an alpha-numeric input device (e.g., a keyboard), a pointing device, a joystick, a gamepad, an audio input device (e.g., a microphone, a voice response apparatus, etc.), a cursor control device (e.g., a mouse), a touchpad, an optical scanner, a video capture device (e.g., a still camera, a video camera), a touchscreen, and any combinations thereof. Input device 632 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 632 may include a touch screen interface that may be a part of or separate from display 636, discussed further below. Input device 632 may be utilized as a user selection device for selecting one or more graphical representations in a graphical interface as described above.

A user may also input commands and/or other information to computer apparatus 600 via storage device 624 (e.g., a removable disk drive, a flash drive, etc.) and/or network interface device 640. A network interface device, such as network interface device 640, may be utilized for connecting computer apparatus 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer apparatus 600 via network interface device 640.

Computer apparatus 600 may further include a video display adapter 652 for communicating a displayable image to a display device, such as display device 636. Examples of a display device include, but are not limited to, a liquid crystal display (LCD), a cathode ray tube (CRT), a plasma display, a light emitting diode (LED) display, and any combinations thereof. Display adapter 652 and display device 636 may be utilized in combination with processor 604 to provide graphical representations of aspects of the present disclosure. In addition to a display device, computer apparatus 600 may include one or more other peripheral output devices including, but not limited to, an audio speaker, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, apparatus, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for projecting a pecuniary strength metric, wherein the apparatus comprises:
at least a processor; and
a memory communicatively connected to the at least a processor, wherein the memory containing instructions configuring the at least a processor to:
receive a pecuniary datum associated with a plurality of pecuniary categories from a user, wherein the plurality of categories user finances, user lifestyle, and user physical health;
generate a plurality of pecuniary scores as a function of the pecuniary datum, wherein each pecuniary score of the plurality of pecuniary scores is associated with one pecuniary category of the plurality of pecuniary categories wherein generating the plurality of pecuniary scores further comprises normalizing by a threshold value wherein the threshold value further comprises an average of each category weight within each pecuniary category of the plurality of pecuniary categories, wherein the plurality of pecuniary scores further comprises:
at least a historical pecuniary score;
an associated time score for each pecuniary score of the plurality of pecuniary scores; and
at least an advanced pecuniary score wherein the at least an advanced pecuniary score comprises a future predicted pecuniary score;
identify a plurality of focus areas as a function of the plurality of pecuniary scores;
generate a holistic pecuniary strategy as a function of the plurality of focus areas and the plurality of pecuniary scores; and
project a pecuniary strength metric of the user as a function of the holistic pecuniary strategy using a pecuniary strength machine-learning process, wherein the pecuniary strength metric comprises an impact of the holistic pecuniary strategy on the user;
implement the pecuniary strength machine-learning process comprising:
iteratively training the pecuniary strength machine-learning process using a pecuniary strength training data, applied to an input layer of nodes, wherein the pecuniary strength training data includes a plurality of historical holistic pecuniary strategies, wherein the historical holistic pecuniary strategies are holistic pecuniary strategies generated previously using a plurality of historical pecuniary scores, wherein the training data is iteratively updated by feeding back the output of the pecuniary strength machine-learning process to update the training data, wherein the input layer of nodes further comprise a plurality of holistic pecuniary strategies, one or more intermediate layers, and an output layer of nodes, wherein the output layer of nodes comprise a plurality of pecuniary strength metrics, by creating one or more connections between the input layer of nodes and the output layer of nodes;
adjusting the one or more connections and one or more weights between nodes in adjacent layers of the pecuniary strength machine-learning process to iteratively update the output layer of nodes by updating the pecuniary strength training data applied to the input layer of nodes; and
calculating a weighted sum of the input layer of nodes by adding a bias to the weighted sum of the input layer of nodes;
projecting the pecuniary strength metric as a function of the trained pecuniary strength machine-learning process; and
display, on a graphical user interface, the pecuniary strength metric comprising:
a simulation of a previous iteration of a generated holistic pecuniary strategy; and
an impact of the holistic pecuniary strategy on the user.

2. The apparatus of claim 1, wherein the pecuniary datum comprises a vitality datum.

3. The apparatus of claim 1, wherein receiving the pecuniary datum comprises:
accepting a pecuniary assessment from the user; and
extracting the pecuniary datum from the pecuniary assessment.

4. The apparatus of claim 3, wherein the pecuniary assessment comprises a data submission of a plurality of documentation from the user.

5. The apparatus of claim 1, wherein the plurality of pecuniary scores comprises a pecuniary curve.

6. The apparatus of claim 1, wherein generating the plurality of pecuniary scores comprises:
generating a first pecuniary score representing a first category; and
generating a second pecuniary score representing a second category, wherein the first category is different than the second category.

7. The apparatus of claim 1, wherein identifying the plurality of focus areas comprises:
comparing a first pecuniary score with a second pecuniary score; and
identifying a focus area as a function of the comparison of the first pecuniary score and the second pecuniary score.

8. The apparatus of claim 1, wherein generating the holistic pecuniary strategy comprises:
training a pecuniary strategy machine-learning process using pecuniary strategy training data, wherein the pecuniary training data comprises a plurality of pecuniary scores as input correlated to a plurality of holistic pecuniary strategies as output; and
generating the holistic pecuniary strategy as a function of the trained pecuniary strategy machine-learning process.

9. The apparatus of claim 1, wherein the pecuniary strength metric comprises a plurality of advanced pecuniary scores.

10. (canceled)

11. A method for projecting a pecuniary strength metric, wherein the method comprises:
receiving, using at least a processor, a pecuniary datum associated with a plurality of pecuniary categories from a user, wherein the plurality of categories user finances, user lifestyle, and user physical health;
generating, using the at least a processor, a plurality of pecuniary scores as a function of the pecuniary datum, wherein each pecuniary score of the plurality of pecuniary scores is associated with one pecuniary category of the plurality of pecuniary categories wherein generating the plurality of pecuniary scores further comprises normalizing by a threshold value wherein the threshold value further comprises an average of each category weight within each pecuniary category of the plurality of pecuniary categories , wherein the plurality of pecuniary scores further comprises:
at least a historical pecuniary score;
an associated time score for each pecuniary score of the plurality of pecuniary scores; and
at least an advanced pecuniary score wherein the at least an advanced pecuniary score comprises a future predicted pecuniary score;
identifying, using the at least a processor, a plurality of focus areas as a function of the plurality of pecuniary scores;
generating, using the at least a processor, a holistic pecuniary strategy as a function of the plurality of focus areas and the plurality of pecuniary scores;
projecting, using the at least a processor, a pecuniary strength metric as a function of the holistic pecuniary strategy using a pecuniary strength machine-learning process, wherein the pecuniary strength metric comprises an impact of the holistic pecuniary strategy on the user;
implementing, using the at least a processor, the pecuniary strength machine-learning process comprising:
iteratively training the pecuniary strength machine-learning process using a pecuniary strength training data applied to an input layer of nodes, wherein the pecuniary strength training data includes a plurality of historical holistic pecuniary strategies, wherein the historical holistic pecuniary strategies are holistic pecuniary strategies generated previously using a plurality of historical pecuniary scores, wherein the training data is iteratively updated by feeding back the output of the pecuniary strength machine-learning process to update the training data, wherein the input layer of nodes further comprise a plurality of holistic pecuniary strategies, one or more intermediate layers, and an output layer of nodes, wherein the output layer of nodes comprise a plurality of pecuniary strength metrics, by creating one or more connections between the input layer of nodes and the output layer of nodes;
adjusting the one or more connections and one or more weights between nodes in adjacent layers of the pecuniary strength machine-learning process to iteratively update the output layer of nodes by updating the pecuniary strength training data applied to the input layer of nodes; and
calculating a weighted sum of the input layer of nodes by adding a bias to the weighted sum of the input layer of nodes;
projecting the pecuniary strength metric as a function of the trained pecuniary strength machine-learning process; and
displaying, using a graphical user interface, the pecuniary strength metric comprising:
a simulation of a previous iteration of a generated holistic pecuniary strategy; and
an impact of the holistic pecuniary strategy on the user.

12. The method of claim 11, wherein the pecuniary datum comprises a vitality datum.

13. The method of claim 11, wherein receiving the pecuniary datum comprises:
accepting a pecuniary assessment from the user; and
extracting the pecuniary datum from the pecuniary assessment.

14. The method of claim 13, wherein the pecuniary assessment comprises a data submission of a plurality of documentation from the user.

15. The method of claim 11, wherein the plurality of pecuniary scores comprises a pecuniary curve.

16. The method of claim 11, wherein generating the plurality of pecuniary scores comprises:
generating a first pecuniary score representing a first category; and
generating a second pecuniary score representing a second category, wherein the first category is different than the second category.

17. The method of claim 11, wherein identifying the plurality of focus areas comprises:
comparing a first pecuniary score with a second pecuniary score; and
identify an area of interest as a function of the comparison of the first pecuniary score and the second pecuniary score.

18. The method of claim 11, wherein generating the holistic pecuniary strategy comprises:
training a pecuniary strategy machine-learning process using pecuniary strategy training data, wherein the pecuniary training data comprises a plurality of pecuniary scores as input correlated to a plurality of holistic pecuniary strategies as output; and
generating the holistic pecuniary strategy as a function of the trained pecuniary strategy machine-learning process.

19. The method of claim 11, wherein the pecuniary strength metric comprises a plurality of advanced pecuniary scores.

20. (canceled)
